(19) United States
(12) Patent Application Publication
(10) Pub. No.: US 2018/0289044 A1
(43) Pub. Date: Oct. 11, 2018

(54) HPP PROCESS FOR DAIRY FOOD

(71) Applicant: CBH FRESH PTY LTD, New South Wales (AU)

(72) Inventor: Adam Cornell, Bondi Junction (AU)

(21) Appl. No.: 15/763,346

(22) PCT Filed: Sep. 29, 2016
(86) PCT No.: PCT/AU2016/050921

§ 371 Date: Mar. 26, 2018

(30) Foreign Application Priority Data
Sep. 29, 2015 (AU) 2015903955

(51) Int. Cl. A23L 3/015; A23C 3/00

(52) U.S. Cl. CPC A23L 3/0155; A23V 2002/00; A23C 3/00

(57) ABSTRACT

The invention relates to a high hydrostatic pressure process for reducing the level of micro-organisms in commercial dairy products.

### TECHNICAL FIELD

The invention relates to the field of commercial food manufacture. In particular, the invention relates to high pressure processing of dairy foods.

### BACKGROUND OF THE INVENTION

Nutritional value and product safety are two of the most important factors influencing food consumer choices at the present time, as well as being of significant importance to food producers and distributors. In the food industry, one of the long-term goals is to assure food safety and extend product shelf life while retaining the characteristics of fresh, preservative-free, and minimally processed foods.

Traditionally, heat-based methods are used to destroy harmful bacteria and reduce the numbers of spoilage organisms to extend shelf life of food products. Such methods are well known and are the subject of highly developed techniques. However, consumer demand for fresher tasting and fresher textured foods is driving the development of new methods of making the energy-intensive process more environmentally friendly, further extending shelf life and producing a product with a taste as close to an untreated product as possible.

The best known technique to slow food decomposition and assure safety is heat pasteurisation. For example, temperatures above 72° C. are used to heat treat dairy food to improve food safety and extend shelf life by effectively inactivating microorganisms and enzymes in the food. However, heat pasteurisation often has adverse effects on the nutritional and sensory attributes of food.

High-pressure processing (HPP) involves application of a high hydrostatic pressure to foods susceptible to decomposition. HPP can inactivate spoiling and/or pathogenic microorganisms.

An advantage of HPP over heat pasteurisation and other thermal processing technologies is the even and instantaneous distribution of pressure energy throughout the product. Because the high pressure is applied to the dairy food in its final packaging, the product is not subject to post-processing contamination with spoiling or pathogenic microorganisms, resulting in a product with a longer shelf life than products that are heat pasteurised and subsequently packaged.

Another advantage of high pressure processing is that microorganisms can be eliminated while maintaining the ‘fresh’ flavour, quality, texture and other sensory properties of the food product, because it is not heat treated.

High pressure processing (HPP) uses pressures up to 900 MPa (c. 9000 atmospheres, c. 135 000 pounds per square inch) to kill many of the microorganisms found in foods, even at room temperature¹. While considerable experimental data has been produced, it was not until the early 1990s that the first commercial food applications of HPP were seen². There are considerable engineering challenges involved in generating and containing the immense pressures in a vessel suitable for food products on a repeatable basis necessary for commercial production. ¹Patterson, M. F. Microbiology of pressure-treated foods. Journal of Applied Microbiology. 2005, 98, 1400-1409.²Patterson, M. F. Microbiology of pressure-treated foods. Journal of Applied Microbiology. 2005, 98, 1400-1409.

Unlike other food processing methods, such as heat pasteurisation or other thermal processing, HPP has had a somewhat limited application to date. As yet, HPP has not been universally applied to all food types on a commercial scale. Some animal and dairy products and shelf-stable low-acid foods cannot be readily treated with HPP on a commercial scale because of the difficulties associated with the engineering of the process, protection of microorganisms by the food matrix and pressure resistant spores that are often present in these products. Indeed, the problem of eliminating some pathogenic microorganisms in commercial dairy and other animal-based food production processes remains a significant challenge for the technology today.

Accordingly, it is an object of the invention to provide a high pressure process for reducing the level of microorganisms in commercial dairy products that ameliorates at least some of the problems associated with the prior art.

### SUMMARY OF THE INVENTION

According to a first aspect of the invention, there is provided a process for reducing the level of active spoilage micro-organisms in commercial dairy products, including on raw milk, the process comprising the steps of: (a) applying a source of high hydrostatic pressure of at least 5200 Bar to the dairy product for a first period of time; (b) removing the source of pressure from the dairy product; (c) reapplying the source of pressure to the dairy product for a second period of time; and optionally repeating steps (a) to (c).

It has been surprisingly found by the inventors that the cycling of the pressure in a HP process through at least two cycles produces an increased lethal effect on populations of certain pathogenic organisms than had hitherto been achieved using a single HP process, particularly in dairy products, especially raw milk.

Preferably, the maximum hydrostatic pressure applied is 6000 Bar or greater.

Best results have also been seen where said first and second periods of time are between 60 and 150 seconds, preferably 90 to 120 seconds; and where the source of pressure is removed for a time period of between 1 to 10 seconds, preferably 5 seconds.

What has been especially noted by the inventors is that this process has been the first to report an >6 log₁₀ reduction of both E. coli and L. Monocytogenes and a 4.3 log₁₀ reduction or more of S. Typhimurium in raw milk. Milk has presented particular challenges in the past regarding the effective use of HPP in producing a microbiologically safe and commercially stable product. It is thought that this is due to idiosyncrasies in the chemical make-up of raw milk.

The particular advantage of achieving these levels of pathogen inactivation with such relatively short cycle times is that the overall throughput of the process can be much higher, creating greater manufacturing efficiency that allows a fully commercial process to be realised.

According to a second aspect of the invention, there is provided the use of a process according to any preceding claim, for the production of a commercial dairy product.

According to a third aspect of the invention, there are provided commercial dairy products produced by the process as described above. Commercial dairy products produced according to this process have been shown to have a shelf life of greater than 40 days, specifically 42 days, at 5° C.

Now will be described, by way of specific, non-limiting examples, a preferred embodiment of the invention.

### DETAILED DESCRIPTION OF THE INVENTION

The invention is embodied in a high pressure process that has been developed for the treatment of raw milk, particularly for bovine milk, to render it microbiologically safe and stable for a commercially viable time period under refrigeration. It will be appreciated that this embodiment is by way of example only and the inventive process could be used to treat a wide range of other dairy products, and food products generally.

Food safety authorities in some jurisdictions mandate a specific log₁₀ reduction in particular types of spoilage organisms that must be achieved in order for the food to be considered commercially sterile and saleable. For example, the New South Wales Food Authority (NSWFA) require a treatment process to achieve a log₁₀ reduction of 5 (i.e. a 100,000× reduction) in pathogenic microorganisms.

In high pressure processing (HPP), there are two key variables that define the treatment process. Every different food type requires testing to ascertain at what point the process has been effective in inactivating the target pathogens. The variables are: time spent under pressure; and the magnitude of pressure applied.

With typical HPP equipment, pressure can be applied up to about 6000 Bar. The time that a food item is placed under this level of pressure must be consistent with commercial food production process requirements and result in elimination or inactivation of a sufficient proportion of the target micro-organisms while maintaining the quality, texture and taste properties of the food.

### High Pressure Process Testing

The following test conditions were applied to five replicates of pre-inoculated milk feedstock:

i. Three pathogens: (Salmonella typhimurium, Listeria monocytogenes, and Staphylococcus aureus).
ii. Two pressure hold times at 6000 Bar: 3 minutes and 4 minutes, as it was postulated that each additional minute of hold time should produce an extra log reduction.

The results at 3 minutes showed a kill of pathogenic bacteria, with log₁₀ reductions of between 2× and 3× for Salmonella and Staphylococcus at four minutes, and 3 to 4 log₁₀ reduction for Listeria. Results at four minutes were slightly better than at three minutes treatment (approximately 1 log₁₀). Taken together, these results were not sufficient to demonstrate equivalence to heat pasteurisation, in which a 5 log₁₀ reduction is achieved.

On this occasion, the raw milk used was incidentally contaminated with >1,100 coliforms and E. coli. These bacteria were not detected in the non-inoculated HP processed control sample, demonstrating at least a log₁₀ reduction of 3.

### Extended Treatment and Cycled Pressure Testing

A further pathogen challenge test was conducted on five replicates using two new test processes:

i. An ‘extended’ treatment of 6000 Bar/90 seconds for 15 minutes; and
ii. A ‘cycled’ treatment process at 6000 Bar for 90 seconds, repeated once immediately.

To date, there is no known reference to the commercial use of either of these treatments in the processing of commercial dairy products. The rationale for testing the cycled process was that the first cycle would induce sub-lethal injury of the cell walls of the microorganisms and that the second cycle would complete the lethal effect of the high pressure on the damaged cell. The extended treatment was tested to measure the effect of a longer period of high pressure on cell death. Of the two processes tested, only the cycled process is likely to be commercially viable, as the extended treatment reduces overall the maximum product throughput.

In the extended treatment trial, pathogens tested were Salmonella typhimurium and Staphylococcus aureus.

The results for the treatment of both bacteria showed a log₁₀ reduction of 5 for Salmonella and a log₁₀ reduction of 2 to 3 for Staphylococcus. Therefore, the required log₁₀ reduction of 5 was only demonstrated for one of the target pathogens in this instance.

The cycled pressure testing was designed with the objective of confirming the impact of the ‘cycled’ process on reduction of Salmonella and testing it on Listeria, and E. coli. Five replicates were tested.

Log reductions of greater than 6 were demonstrated for E. coli and Listeria. In the case of E. coli and Listeria, this was higher than the equivalent log reductions under process conditions of 6000 Bar for 3 minutes. The Salmonella challenge showed inconsistent results initially between replicates so that log reductions of 3 and >6 were demonstrated. Low log reduction counts of Staphylococcus were reproduced from previous trials.

Shelf life testing yielded a potential shelf life of greater than 42 days at 5° C., and a longer shelf life than that achieved using the 3 minute standard cycle, an superior to those obtained at 4000 Bar and at 5000 Bar, both of which indicated microbiological spoilage at approximately 23 days.

A further trial was conducted, with the objective to test for the first time the impact on Campylobacter jejuni. Under these test conditions, Campylobacter demonstrated a degree of resistance to high pressure with a log reduction of 1.2.

The results of the shelf life and challenge testing for the raw milk product are shown in Table 1.

In most food products containing E. coli, Listeria, Salmonella, Campylobacter or Staphylococcus aureus, holding the product at pressures up to 6000 Bar for a period of 3 minutes would be sufficient to achieve a log₁₀ reduction of 5 in the pathogen level. However, in this trial with raw milk, these conditions were found to be insufficient to achieve a log₁₀ reduction of 5 in Listeria, Salmonella, Campylobacter and Staphylococcus due to the protection of the bacterial cells afforded by the food matrix typical of raw milk. A 4-minute hold at 6000 Bar did achieve a log₁₀ reduction of 5 for Listeria, but not for Salmonella.

Testing was then done using a cyclic approach, as shown in Table 1. The cyclic approach held the raw milk product at 6000 Bar for two time periods of 90 seconds, one immediately following the other. It was surprisingly discovered that this shorter, cyclic approach at 6000 Bar was successful in achieving a superior log reduction of E. coli and Listeria monocytogenes compared with a more standard 3 minute pressure treatment at the same pressure, and produced a longer shelf life. The required log reduction of 5 (equivalent to heat pasteurisation) was achieved using the cyclic approach for Listeria monocytogenes and E. coli.

It is proposed that those bacterial pathogens that were not reduced by 5 log using any of the tested high pressure process conditions (Salmonella, Staphylococcus aureus and Campylobacter jejuni) can be controlled by applying hygienic raw milk production techniques and animal health strategies in combination with raw milk compliance testing prior to high pressure processing, to produce a commercially viable, safe unheated milk product with a longer shelf life.

The inventors have found that a cycled HPP has a unique, significant impact on the reduction in numbers of Salmonella Listeria, and E. coli) in raw milk. Such results may also be applicable to other dairy products, particularly those using raw milk as an ingredient.

It will be appreciated by those skilled in the art that the above described embodiment is merely one example of how the inventive concept can be implemented. It will be understood that other embodiments may be conceived that, while differing in their detail, nevertheless fall within the same inventive concept and represent the same invention.

1. A process for reducing the level of active spoilage and pathogenic micro-organisms in an untreated dairy product, the process comprising the steps of:
a. applying a source of high hydrostatic pressure of at least 5200 Bar to the untreated dairy product for a first period of time;
b. removing the source of pressure from the dairy product;
c. reapplying the source of pressure to the dairy product for a second period of time; and
d. optionally repeating steps (a) to (c) to produce a treated dairy product,
wherein there is no initial heat pasteurisation step of said untreated dairy product.

2. The process of claim 1 wherein the maximum hydrostatic pressure applied is 5500 Bar or greater.

3. The process of claim 1 wherein the maximum hydrostatic pressure applied is 5800 Bar or greater.

4. The process of claim 1 wherein the maximum hydrostatic pressure applied is 6000 Bar or greater.

5. The process of claim 1, wherein said first period of time is between 60 and 120 seconds.

6. The process of claim 1, wherein said first period of time is about 90 seconds.

7. The process of claim 1, wherein said second period of time is between 60 and 150 seconds.

8. The process of claim 1, wherein said second period of time is about 120 seconds.

9. The process of claim 1, wherein the source of pressure is removed for a time period of between 1 to 10 seconds.

10. The process of claim 1, wherein the source of pressure is removed for about 5 seconds.

11. The process of claim 1, wherein the untreated dairy product is raw milk.

12. The process of claim 1, wherein the treated dairy product has a shelf life of greater than 40 days at 5° C.

13. The process of claim 1, wherein the treated dairy product has a >6 log₁₀ reduction of both E. coli and L. Monocytogenes.

14. The process of claim 1, wherein the treated dairy product has a >4.3 log₁₀ reduction of S. Typhimurium.

15. The process according to claim 1, wherein the process comprises repeating steps (a) to (c) to produce a treated dairy product.

16-20. (canceled)

21. The process according to claim 1, wherein the process further comprises producing cream, skim milk, low fat milk, kefir, yoghurt, buttermilk, or cheese from the dairy product.
